(19) United States
(12) Patent Application Publication
(10) Pub. No.: US 2008/0024917 A1
(43) Pub. Date: Jan. 31, 2008

(54) Holographic magnetic stripe demetalization security

(76) Inventor: John Hynes, Reisterstown, MD (US)

Correspondence Address: C. Andrew Im;FULBRIGHT & JAWORSKI L.L.P., 666 Fifth Avenue, New York, NY, 10103, US

(21) Appl. No.: 11/879,902

(22) Filed: Jul. 18, 2007

Related U.S. Application Data
(63) Continuation-in-part of application No. 11/484,984, filed on Jul. 11, 2006.
(60) Provisional application No. 60/776,717, filed on Feb. 24, 2006.
(60) Provisional application No. 60/776,720, filed on Feb. 24, 2006.
(60) Provisional application No. 60/776,718, filed on Feb. 24, 2006.
(60) Provisional application No. 60/831,634, filed on Jul. 18, 2006.

(51) Int. Cl. G11B 5/78

(52) U.S. Cl. 360/134

(57) ABSTRACT

A secured holographic magnetic tape comprising a magnetic layer for encoding data, an embossable layer for embossing a hologram, and a metal layer. The metal layer comprises a plurality of sections forming a pattern based on a predetermined magnetic signature of the tape. A method of making the secured holographic magnetic tape and incorporating the same to a card.

### RELATED APPLICATION

The present application is a continuation-in-part of co-pending U.S. patent application Ser. No. 11/484,984, which claims the benefit of the priority date of provisional application Ser. Nos. 60/776,717, 60/776,720 and 60/776,718, all filed Feb. 24, 2006, each of which is incorporated by reference in its entirety. The present application also claims benefit of the priority date of provisional patent application No. 60/831,634, filed Jul. 18, 2006, which is incorporated by reference in its entirety.

### BACKGROUND OF THE INVENTION

The present invention relates to a holographic magnetic stripe, more particularly to a secured holographic magnetic stripe.

“Skimming” fraud generally involves the copying of data encoded on a credit card's magnetic stripe in order to later use that data to manufacture counterfeit cards. These counterfeit cards are then illegally disseminated and used to rack up millions of dollars in illegal charges. Skimming is escalating at an alarming rate and has become a growing worldwide problem, costing the industry over one-billion dollars a year. In fact, skimming is considered by many to be the most rapidly growing type of fraud for magnetic stripe encoded cards in the financial transaction markets.

By its very nature, skimming takes advantage of the fact that the magnetic stripe on each credit card can be copied virtually to perfection, with no discernable differences between a copy and the original magnetic stripe. Generally, magnetic stripes can be produced cheaply, easily, and rapidly. As such, the magnetic stripe card is probably the most versatile portable data carrying device. However, this inexpensive ease of use, has also made the magnetic stripe card particularly amenable to fraud. While there have been several attempts to defeat skimming by using magnetic and optical characteristics of the magnetic stripe or card, the currently available attempts to address the problem are: not reliable in transferring or reading data; restrict the functionality of the card; require reengineering or a new implementation of the current point of sale infrastructure; and are costly to implement.

Therefore, there is a need in the art for magnetic stripes that include a security property for defeating skimming that is reliable, easily implemented in the current POS infrastructure; and that is cost-effective.

### SUMMARY OF THE INVENTION

An object of the present invention is to provide a secured holographic magnetic tape.

In accordance with an exemplary embodiment of the present invention, the secured holographic magnetic tape comprises a magnetic layer for encoding data, an embossable layer for embossing a hologram, and a metal layer. The metal layer comprises a plurality of sections forming a pattern based on a predetermined magnetic signature of the tape.

In accordance with an exemplary embodiment of the present invention, the holographic magnetic tape card comprises a carrier and a secured holographic magnetic tape on the carrier. The secured holographic magnetic tape comprises a magnetic layer for encoding data, an embossable layer for embossing a hologram, and a metal layer. The metal layer comprises a plurality of sections forming a pattern based on a predetermined magnetic signature of the tape.

In accordance with an exemplary embodiment of the present invention, the method of securing a holographic magnetic tape comprising the steps of: depositing an embossable resin layer for embossing a hologram on a base film; depositing a metal layer; dividing the metal layer into a plurality of sections to form a pattern based a predetermined magnetic signature of the tape; and depositing a magnetic layer for encoding data.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIG. 1 is a schematic diagram of the triboelectric charges generated on an exemplary conductive layer on a non-conductive carrier, such as a metalized/conductive magnetic stripe on a PVC card, when the card is swiped in the reader;

FIGS. 2A-B are schematic diagrams of the holographic magnetic stripe on a substrate, such as a non-conductive/insulator PVC card, in accordance with an exemplary embodiment of the present invention;

FIG. 3 is a schematic diagram showing an exemplary electrostatic discharge from the exemplary conductive layer on a non-conductive carrier to an electronic device;

FIG. 4 is a schematic diagram showing an exemplary generation of additional triboelectric charges on the exemplary conductive layer on a non-conductive carrier from the human finger holding the card;

FIGS. 5A-B are schematic diagrams illustrating the exemplary conductive layer being divided into sections in accordance with exemplary embodiment of the present invention;

FIG. 6A-B are schematic diagrams illustrating the process of dividing the exemplary conductive layer into sections in accordance with an exemplary embodiment of the present invention;

FIG. 7 is a schematic diagram illustrating the reduction or elimination of the electrostatic discharge from the exemplary conductive layer by dividing the exemplary conductive layer into two examples of the metal reduced sections (the line pattern on the left and the dot pattern on the right) in accordance with an exemplary embodiment of the present invention;

FIG. 8 is a schematic diagram illustrating the exemplary conductive layer being divided into two sections in accordance with exemplary embodiment of the present invention;

FIGS. 9A-B are schematic diagrams showing the demetalization process for dividing the conductive layer into sections in accordance with an exemplary embodiment of the present invention;

FIG. 10 is a diagram showing a line demetalization of a metalized film in accordance with an exemplary embodiment of the present invention;

FIG. 11 is a diagram showing a magnified dot pattern demetalization of a metalized film in accordance with an exemplary embodiment of the present invention; and

FIGS. 12-13 are diagrams of an exemplary paper or plastic banknote with a metalized holographic thread (or ribbon) and a metalized holographic patch.

FIG. 14 is a schematic diagram of the fully constructed holographic magnetic tape without the demet pattern in accordance with an exemplary embodiment of the present invention.

FIG. 15 is a schematic diagram of the fully constructed holographic magnetic tape with resist coating applied over the non-demet aluminum areas in accordance with an exemplary embodiment of the present invention.

FIGS. 16A-D are graphs showing the variation in signal amplitude from Track 2 on a magnetic stripe card for a data recording of all binary zeroes in accordance with an exemplary embodiment of the present invention.

FIG. 17 is a photomicrograph of an encoded signal in Track 2 for all binary zeroes according to an exemplary embodiment of the present invention.

FIG. 18 is a graph showing the variation in signal amplitude from Track 2 data encoded on top of the holographic magnetic stripe according to an exemplary embodiment of the present invention.

### DETAILED DESCRIPTION OF THE EMBODIMENTS

The inventive anti-skimming security measures of the present invention can be applied to any holographic magnetic stripes, that have been treated for ESD in another series of embodiments. These inventive holographic magnetic stripes or tape greatly reduce or minimize electro-static discharge (ESD) from the metallic components in the holographic portion of the magnetic stripe by having an aluminum layer broken down into small sections. These sections can be produced by selectively removing the aluminum into fixed patterns by a process known as demetalization (demet). This demet pattern produces a repetitive pattern of resist/aluminum sections (dots) that can modulate the magnetic signal amplitude into the repetitive pattern of the demet. This repetitive modulation of the readback signal amplitude can be used as a magnetic signature or fingerprint of the magnetic stripe in accordance with an embodiment of the present invention. According to an exemplary embodiment of the present invention, the demet signature can then be used to tie the encoded data to the holographic magnetic stripe card, thereby greatly minimizing or preventing data skimming from one card to another and counterfeiting of the card. The holographic magnetic demet security of the present invention will have minimum impact on POS terminals by requiring only a change to the decode algorithm in the decode chip. The robustness of the demet pattern provides a more durable holographic magnetic signature and a more reliable performance of these security features over previous anti-skimming magnetic stripe systems. The demet pattern is internal to the structure of the tape and is not subject to wear and abuse. The holographic magnetic demet security should then be very durable and repeatable over the life of the card while being extremely difficult to reproduce.

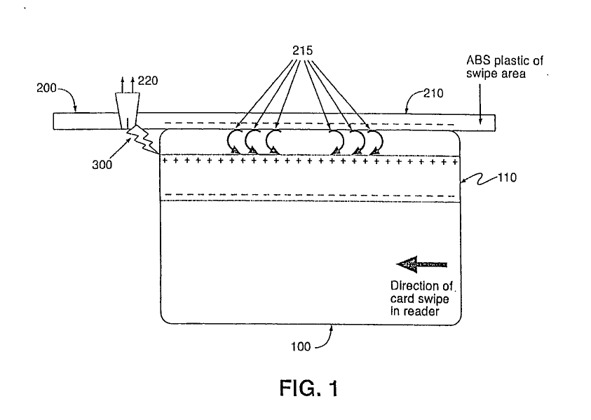

As indicated above, the inventive security feature of the present invention is applied to a holographic magnetic stripe that reduces or eliminates ESD. Generally, there are many examples of insulator devices that carry conducting components that can be charged and then discharged into an electronic device. In one series of embodiments, the inventive method for reducing ESD is applicable to reduce or eliminate ESD from a conductive component 110 on an insulator 100. Turning now to FIG. 1, the inventive method of producing a holographic magnetic stripe that reduces the ESD is described as applied to a polyvinyl chloride (PVC) plastic card (insulator) 100 with a metal conductive coated magnetic stripe (metal component) 110 to reduce or eliminate ESD from a metal component 110 on an insulator 100. A PVC plastic card 100 carrying a metalized magnetic stripe (“mag stripe”) 110 is inserted into a magnetic stripe card reader 200, such as a point of sale (POS) terminal 200, where ESD 300 from the metalized magnetic stripe 110 into the POS terminal 200 can disrupt the operation of the POS terminal 200. The following descriptions describe how a conductor or conductive layer 110 on a non-conducting carrier 100 can hold charge that can disrupt electronic devices 200 if the charged conductor 110 and non-conductor carrier 100 are inserted or placed in contact with an electronic device 200.

Plastic cards 100, such as credit cards, automatic teller machine (ATM) cards, charge cards, transit cards, phone cards, stored-value cards, gift cards and debit cards, are typically made from PVC plastics, which can be triboelectric. The triboelectric property of the PVC produces an electrical charge when rubbed against another plastic such as acrylonitrile butadiene styrene (ABS). Magnetic swipe readers (MSR) 210 in the POS terminals 200 are often made from ABS plastic. When the PVC card 100 is swiped in the MSR 210, a triboelectric charge can develop between the ABS and the PVC card 100. The PVC card 100 is left with a positive or negative charge and the body of the MSR is left with an equal and opposite positive or negative charge. An example of such build up of the triboelectric charges from the frictional force of swiping the card 100 is shown in FIG. 1, where negative triboelectric charges build up in the ABS plastic of the magnetic swipe area of the MSR 210. The electric field lines 215 generated by the triboelectric charges on the magnetic swipe area of the MSR 210 induce a positive charge at the top edge of the metalized magnetic stripe 110 and an opposite negative charge on the bottom edge of the metalized magnetic stripe 110.

The electrical charge developed on the card 100, as it moves through the MSR 210, can reach voltages in excess of 1,000 to 3,000 volts over the 14.3 square inch surface area (front and back surface area of card) of the standard International Standards Organization (ISO) specification plastic card. This has been shown to have a total charge on the card 100 of upwards to 2-3 nano coulombs which translates to a capacitance of 1-3 Pico farads on the PVC card 100. The PVC card 100 and metalized magnetic stripe 110 acts like a capacitor and can discharge that stored charge into a low impedance current drain to ground when given an opportunity. Such opportunity can occur when the metalized magnetic stripe 110 of the PVC card 100 encounters the metal magnetic read head 220 in the MSR 210, as shown in FIG. 1.

The metal read head 220 consists of a metal case and a metal core that can capture the magnetic flux emanating from the encoded magnetic stripe 110 and can convert that captured magnetic flux into electrical pulses. When the time varying magnetic flux from the magnetic stripe 110 reaches the read coil of the metal core of the read head 220, the magnetic flux changes are converted into electrical signals by the read coil, which can be decoded by the solid state chips in the read circuits of the MSR 210 or mother board of the POS terminal 200.

If the metal read head 220 encounters an electrically charged PVC card 100, the electrical charges on the metalized magnetic stripe 110 of the card 100 can discharge from the metalized magnetic stripe 110 into the metal read head 220 of the POS terminal 200. This can disrupt the function of the POS terminal 200 if the POS terminal 200 has low tolerance to ESD. The electrical charges then can find their way to ground or to various electronic components, such as solid state chips, of the POS terminal 200. The conduction of the stored electrical charge off the conductive layer or metalized magnetic stripe 110 is a function of the resistivity of the conductive layer or magnetic stripe 110 of the PVC card 100. The electrical charge on the metalized magnetic stripe 110 will generally flow off the metalized magnetic stripe 110 and into the read head 220. The triboelectric charges generated and stored on the card 100 as the card 100 is swiped along the ABS of the MSR 210 can discharge into the magnetic read head 220 of the MSR 210 when the magnetic stripe 110 comes in contact with the metal read head 220 of the POS terminal 200. The MSR 210 and decode electronic circuits in POS terminals 200 are typically designed to deal with such discharge of the electric charges generated by the triboelectric movement of the card 100 through the MSR 210 and stored on the card 100. However, certain POS terminals 200 in the marketplace are not adequately designed to effectively deal with the ESD (i.e., low tolerance to ESD) from the metalized magnetic stripe 110. Accordingly, in accordance with an exemplary embodiment of the present invention, the insulator 100 carries a discontinuous metal component 110 (or metal component 110 with physical breaks therein) to reduce the accumulation of electric charges therein, thereby reducing any potential ESD. That is, for example, the PVC card 100 has discontinuous metalized layer over the magnetic stripe 110 to accommodate existing POS terminals 200 with low tolerance to ESD. Therefore, the present invention proceeds upon the desirability of eliminating or reducing the amount of ESD energy that an insulator or non-conductive carrier 100 carrying a metal or conductive component 110 can discharge into an electronic device 200 by dividing the conductive component 110 into multiple sections. This advantageously minimizes or prevents operational or functional disruption of the electronic device 200 due to ESD.

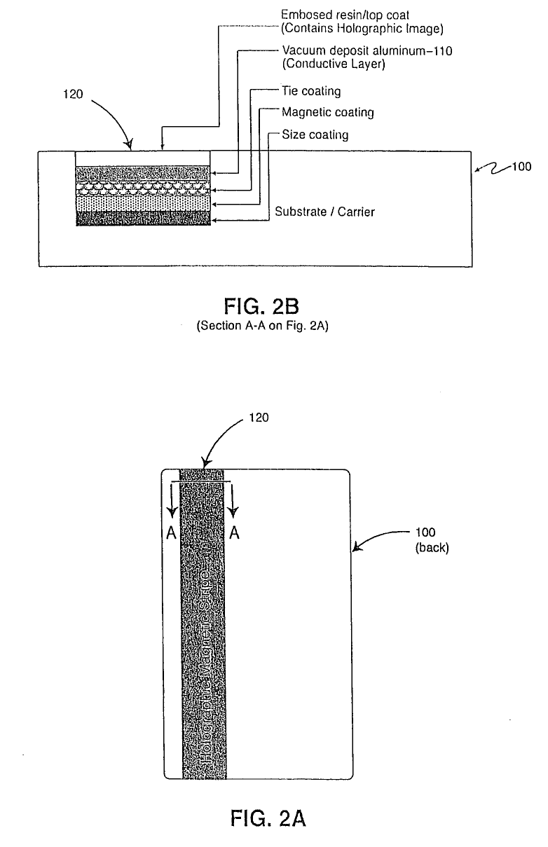

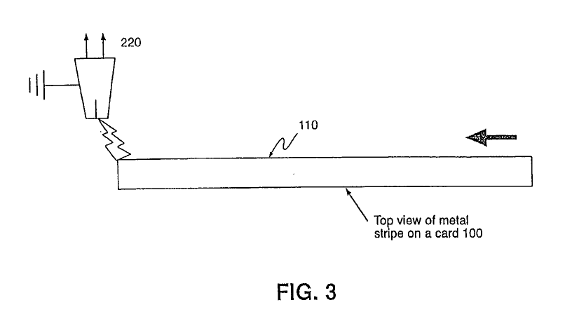

An example of a metal coated or metalized magnetic stripe 110 on PVC cards 100 is a holographic magnetic stripe 120, as shown in FIG. 2A. A cross-sectional view of an exemplary holographic stripe 120 is shown in FIG. 2B. The holographic magnetic stripe 120 comprises a conductive metal portion (e.g., vacuum deposited aluminum, copper, aluminum/chrome alloys, etc.) that provides the reflective condition necessary to view the holographic image in the holographic magnetic stripe 120. The metallic portion of the magnetic stripe 110 typically has resistance values ranging from 50 ohms to several thousand ohms. The resistance of the metallic portion of the magnetic stripe 110 is typically low enough to provide a conductive path for the triboelectric charges on the card 100 to discharge through the magnetic read head 220 and into the electronics or the ground path of the POS terminal 200, as shown in FIG. 3.

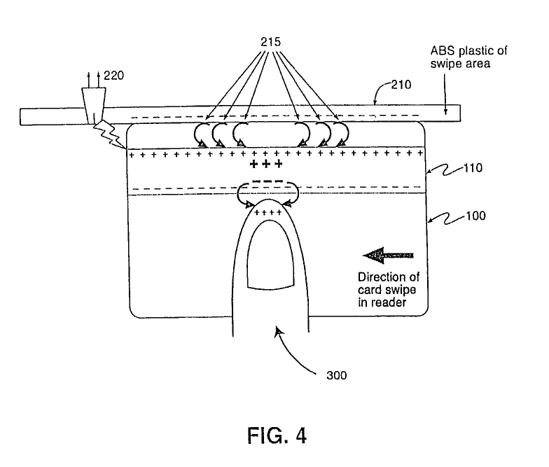

The stored electrostatic charges on the insulator or card 100 and the metallic magnetic stripe 110, which can result in the ESD into the read head 220, can come from several sources. The rubbing action of the card 100 against the surfaces of the magnetic stripe reader 210 can generate the triboelectric charges. Typically, the major area of the magnetic stripe reader 210 comprises ABS plastic, as shown in FIG. 1. The human body is another source of triboelectric charges. The human body can generate the triboelectric charges from various frictional forces, such as from walking, removing card from the wallet, etc. An example of such triboelectric charges from the human body is shown in FIG. 4, wherein the human finger 300 is positively charged by the frictional forces generated from the movement of body as it moves across a carpet for example and as it holds the card 100 during the swipe. The electric field from the positive charges on the finger induces more negative and positive charges on the metalized magnetic stripe 110, thereby increasing or decreasing the charge separation on the metalized magnetic stripe 110. Additionally, electrostatic charges can be left behind in the magnetic swipe area of the terminal 200 from the previous card swipe. Further, piezoelectric charges from a freshly laminated PVC card 100, which are generally trapped charges, can induce free charges within the metal magnetic stripe 110.

All of these sources for electrical charges (Positive or Negative) can result in discharge of the electrostatic charges into an electrical or electronic device 200, such as a POS terminal 200. The electrostatic discharge from the metalized magnetic stripe 110 to the metal component of the magnetic read head 220 provides a conductive path for such ESD (i.e., electrical current) into various electrical circuits of the POS terminal 200. This can temporarily disable the POS terminal 200 having low tolerance to ESD, requiring re-booting of the terminal 200 or worse, electrical circuits within the terminal can be shorted resulting in terminal failures.

The electrical charge can be stored on the metal or conductive layer 110 due to the capacitance of the conductive layer 110 and the insulator or non-conductive layer 100. The capacitance is defined as the amount of charge q that can be stored on a capacitor for a given voltage. The capacitance (C) is a measure of the amount of charge (q) stored on each plate for a given potential difference or voltage (V) which appears between the plates:
C=q/V

A capacitor value directly relates to the area of the plate or surface holding the charge. The larger the area of the plate, the more charge can be placed onto that area, thereby increasing the capacitance.

$$C \approx \frac{ɛ A}{d} ; A ⪢ {d}^{2}$$

Where A is the area of the capacitor, d is the separation of the two metallic components of the capacitor and ∈ is the dielectric constant of any material between the metal components.

The energy stored on a capacitor is related to the size of the capacitance or the square of the charge (Q) stored on the capacitor.

$${E}_{stored} = \frac{1}{2} {CV}^{2} ⇔ {E}_{stored} = \frac{1}{2} \frac{{Q}^{2}}{C}$$

When capacitors are linked in series, the overall capacitance is reduced and the total voltage is divided between the number of capacitors. The total capacitance and charge storage capacity of two capacitors linked in series is less than the capacitance and charge storage capacity of the individual capacitor. That is, the capacitance and the charge storage capacity of the capacitor can be reduced by connecting the capacitor in series with another capacitor.

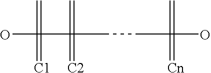

$$\frac{1}{{C}_{eq}} = \frac{1}{{C}_{1}} + \frac{1}{{C}_{2}} + … + \frac{1}{{C}_{n}}$$

If all of the capacitors are of equal size C then Ceg=C/n.

Accordingly, for example, the present invention utilizes this characteristic of a capacitor to reduce the charge stored on the conductive component 110 of an insulator 100, thereby reducing the energy stored on the conductive component 110. This advantageously reduces the amount of charge and energy discharged into an electronic device 200 when the insulator 100 comprising the conductive component 110 is inserted or comes in contact with the electronic device 200 such that the charge (capacitance) stored on the conductive component 110 discharges to ground or into the electronic device 200. In accordance with an embodiment of the present invention, the overall capacitance of the conductive component 110 can be reduced by dividing the conductive component 110 into many smaller and approximately equally sized sections to provide a discontinuous conductive component. The sections essentially function as multiple capacitors linked in series (e.g., n equal sized capacitors), thereby reducing the overall capacitance of the conductive component 110. The effective capacitance of the conductive component 110 divided into n equal parts linked in series is C/n, where C is the capacitance of the original continuous conductive component 110. This advantageously reduces the overall charge and energy stored on the conductive component 110 by factor of n, thereby greatly reducing the likelihood that ESD from the conductive component 110 of the insulator 100 will damage the electronic component of the electronic device 200.

In accordance with an exemplary embodiment of the present invention, the capacitance of the metalized layer 110 (e.g., a holographic magnetic stripe 120) is reduced by dividing the metalized layer 110 into many pieces (or many capacitors). That is, the metalized layer 110 is divided into many smaller and approximately equally sized capacitors linked in series (e.g., n equal sized capacitors), thereby reducing the overall capacitance of the metalized layer 110. Since the effective capacitance of the metalized layer 110 is now reduced by factor of n, this advantageously reduces the overall charge and energy stored on the metalized layer 110 by a factor of n as well, thereby reducing the level of ESD from the metalized layer 110. Accordingly, by reducing the level of electrostatic charges stored on the metalized layer 110, the present invention enables the insulator 100 comprising the metalized layer 110 to be used on any electronic device 200, even if the electronic device 200 has low tolerance to ESD.

Moreover, since the area of each metalized section is reduced, the capacitance of each non-connected metalized portion is significantly lower than the total capacitance of the metalized layer, thereby lowering the charge storage capacity of the metalized layer 110.

Since a conductor 110 on a non-conducting carrier 100 can hold charge that can damage electronic devices 200 (especially electronic devices with low tolerance to electrostatic discharge), the conducting layer 110 of the present invention is constructed as a discontinuous conductive layer 110 to eliminate or greatly reduce the electrostatic discharge, thereby minimizing or eliminating any potential ESD damage to the electronic device 200. In accordance with an embodiment of the present invention, the conductor 110 on the non-conducting carrier 100 is divided into n-sections of approximately equal or unequal areas that can be used to block or reduce the discharge of the accumulated charges (ESD) from any one or more of the n-sections. It is appreciated that the non-conductive carrier 100 can comprise a plurality of conductors 110, each of which can be divided into different number of sections of approximately equal or unequal areas. Each section can be a line, dot, irregular shaped dots (e.g., birds or corporate logos) or other non-connecting shapes, etc.

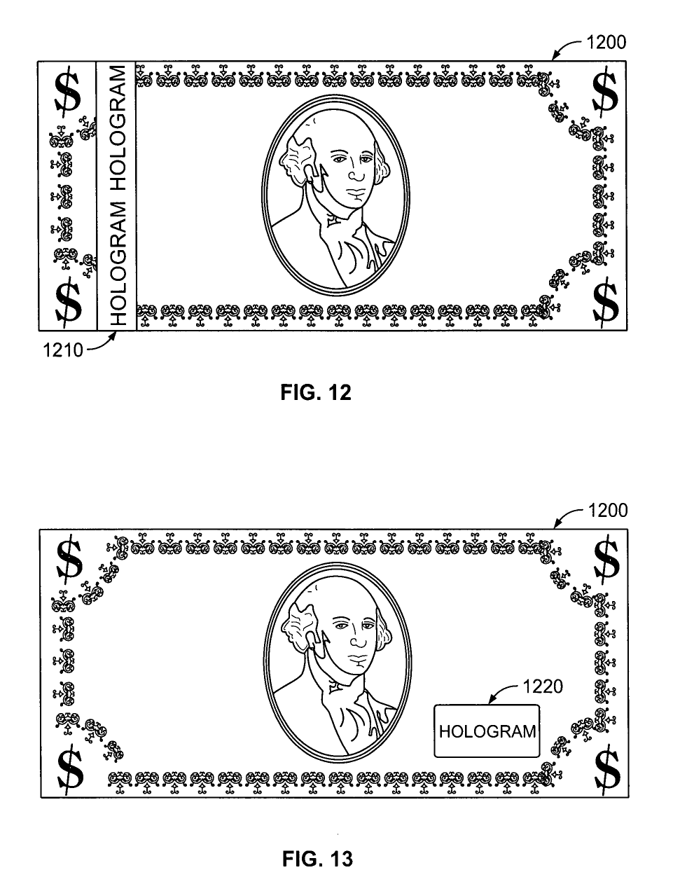

Turning now to FIGS. 12 and 13, a plastic or paper banknote 1200 comprising a metalized holographic thread or ribbon 1210 or a metalized holographic patch 1220 is used herein as an example to illustrate the inventive method of dividing the conductive layer 110 (i.e., the metalized holographic thread 1210) into n-sections. The metal holographic thread 1210 or metalized holographic patch 220 (i.e., the conductive portion of the banknote) on the non-conductive carrier (i.e., the banknote 1200) is divided into n-sections to block or reduce the accumulation of electrostatic charge on the banknote 1200, which can discharge when the banknotes 1200 are counted or processed by an electronic device. By dividing the conductive portion (i.e., the metalized holographic thread 1210 or the metalized holographic patch 1220) of the non-conductive carrier (i.e., the banknote 1200) into n-sections, where each section is isolated from the other sections, the electrical charge carried by the conductive section (i.e., the metalized holographic thread 1210 or the metalized holographic patch 1220) can be blocked from discharging into an electrical device 200 when the conductive portion comes in contact with the electrical device 200. This can occur when the banknotes 1200 are counted or processed by sorting or counting machine.

In accordance with an exemplary embodiment of the present invention, the metalized magnetic stripe 110 (or holographic magnetic stripe 120) on the plastic card 100 is divided into n-sections to block or reduce the accumulation of electrostatic charge on the plastic card 100, which can discharge when the cards comes in contact with the POS terminal 200. In the holographic magnetic stripe 120, the hologram carried on the holographic magnetic stripe 120 is typically made visible by an aluminum metallic layer within the holographic magnetic stripe 120. By dividing the conductive portion (i.e., the aluminum metallic layer of the holographic magnetic stripe 120) of the non-conductive carrier (i.e., the plastic card 100) into n-sections, where each section of the aluminum metallic layer is isolated from the other sections of the aluminum metallic layer, the electrical charge carried by each conductive section can be blocked from discharging into the POS terminal 200 when the card 100 is swiped or inserted into the POS terminal 200. Alternatively, sections can be connected as long as each of the connected sections do not produce ESD events greater than that tolerated by the POS terminal. As noted herein, since the total capacitance of the conductive section is lowered by a factor of n and each conduction section has a lower capacitance, the accumulated charge in each section is not sufficient to discharge (or the ESD is sufficiently low from each conduction section that it is essentially harmless to the electronic device) when the card 100 comes in contact with the POS terminal 200.

Any known method can be used to divide the conductive portion (i.e., the metal layer) 110 of the non-conductive carrier 100 into n-sections to block or reduce ESD. In accordance with an exemplary embodiment of the present invention, the method of reducing the electrostatic discharge comprises laser ablating or engraving lines in the metal or conductive layer 110 (e.g., the aluminum or metal layer (e.g., copper, aluminum/chrome alloys, etc.) in the holographic magnetic stripe 120 or the metalized holographic thread 1210), such that the conductive layer 110 is divided into equal n-sections of x width, e.g., approximately 0.10 inch.

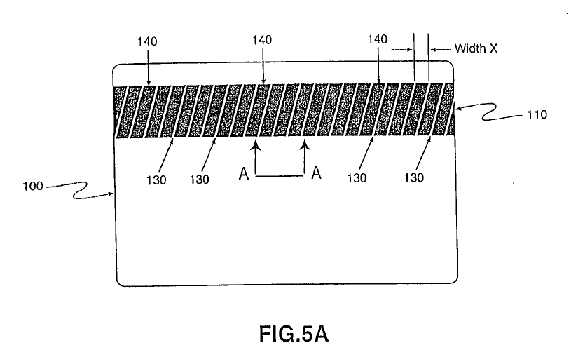

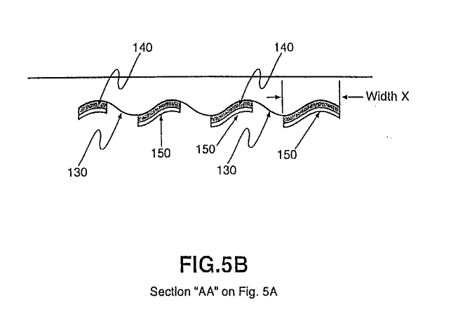

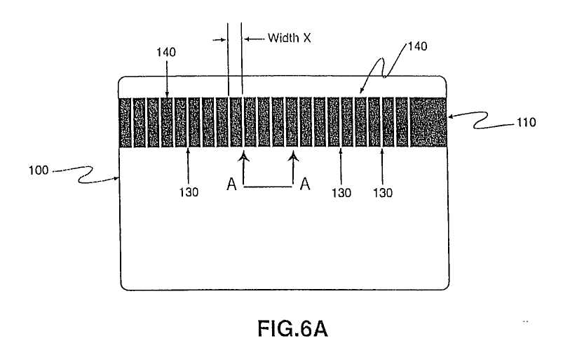

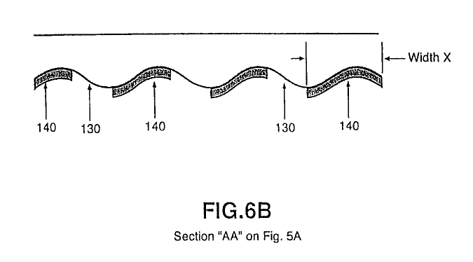

In accordance with an embodiment of the present invention, a laser is used to remove the metal from the metal or conductive layer 110 on a non-conducting carrier 100 by scribing a pattern, such as a vertical line, in the metal layer 110. For example, a laser is used to scribe a vertical line pattern in the metal layer 110, the metal layer of the metalized holographic thread 1210, the aluminum layer of the holographic magnetic stripe 120 or the metalized holographic patch 1220, as shown in FIGS. 5-8 and 10-11, thereby dividing the metal layer into equal n-sections 140 of x width.

To construct a holographic magnetic tape in accordance with an exemplary embodiment of the present invention, aluminum or other metal is added to the holographic tape by evaporating the metal, such as aluminum, copper, aluminum/chrome alloys, etc., onto the polyester backing with a release layer and an embossable layer already on a web. The metalized (or aluminized) web is then passed in front of a laser tuned to the infrared or ultraviolet potion of the spectrum, which burns away the metal (or aluminum) in a line or pattern prescribed by the laser beam or conductive stylus engraving.

As shown in FIGS. 5-8, the placement of the line (or pattern) is set such that the continuous metal (or aluminum, copper, aluminum/chrome alloys, etc.) layer or tape 110 is broken into short sections 140 separated by the laser cut line with no metal (or aluminum, copper, aluminum/chrome alloys, etc.) in the gap 130 between the metal sections 140 of the tape 110. The length x of these metal sections 140 should be small enough so that the overall capacitance of each section 140 is sufficiently low to limit or prevent accumulation electrical charges in each section 140, yet with sufficient brightness.

If the charge q in a section 140 (q=C×V where C is the capacitance of the section and V is the voltage produced by that charge in that section) is sufficiently low, then the electrostatic discharge into an electronic device 200 is sufficiently small that it does not affect the functionality of that electronic device 200. The maximum length and width (area) of any section 140 is limited by the maximum charge that can be accumulated on the non-conductive carrier 100 (i.e., the PVC card 100) so it can operate with an electronic device 200 having low tolerance to ESD. It is appreciated that the maximum charge is a function of capacitance, tribocharging, humidity and surface conditions of the non-conductive carrier 100.

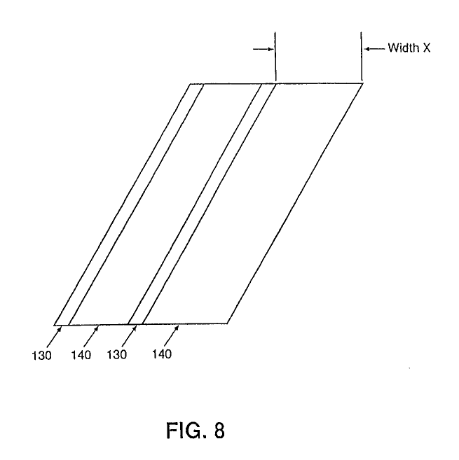

The laser engraved pattern can comprise vertical lines that are perpendicular to the length of the metal tape 110 as shown in FIG. 5A or at an angle to the metal tape direction as shown in FIGS. 5B and 8. It is appreciated that the spacing of the laser engraved line or gap 130 between the sections of the conductive aluminum or metal tape 110 must be wide enough to suppress the ability of the electrical charges, driven by the voltage, to jump the gap 130 and continue to conduct down the metal tape 110 and into the electronic device 200 that comes in contact with the metal tape 110. Therefore, the size of the metal section 140 and the width of the gap 130 can be adjusted to suit a particular design. For example, these two parameters can be adjusted to provide a holographic pattern with the smallest metal sections 140 (e.g., at least approximately 0.10 inch in width) but with sufficient brightness to provide adequate viewing of the hologram.

In accordance with an embodiment of the present invention, sections of the metal tape or layer 110 are removed by chemically etching away sections of the metal (i.e., aluminum, copper, aluminum/chrome alloys, etc.) using an acid etch or a caustic wash solution (i.e., a demetalization process), as shown in FIGS. 6B, 8 and 9A-B. The areas of the metal tape 110 not to be removed are protected by a chemical resist coating 150 FIG. 5b that can be printed onto the metal tape 110 with a gravure cylinder or other applicable printing method. The gravure cylinder is etched in a pattern to be used to protect the aluminum (i.e., metal) on the web of construction that comprises the aluminum layer.

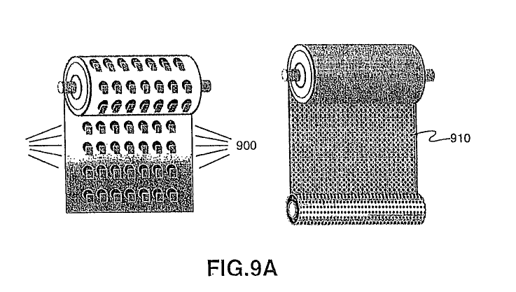

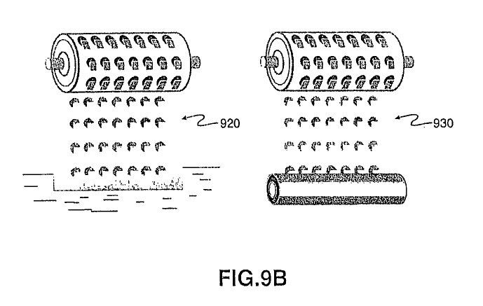

As shown in FIGS. 9A-9B, the demetalization process is used in accordance with an exemplary embodiment of the present invention to generate a discontinuous conductive layer (i.e., holographic metal layer) by selectively removing the metal (i.e., aluminum) from the holographic layer in a specified pattern. A roll of the holographic embossed image is metalized with aluminum in step 900. A gravure cylinder (or other comparable printing method) prints chemical resist pattern (i.e., a dot or other geometric shape resist pattern) on the roll aluminized film for selectively protecting and retaining the aluminum sections on the web from the caustic wash in step 910. The gravure cylinder prints the chemical resist in those areas of the aluminized film where the aluminum is to be kept and does not print any chemical resist in those areas where the aluminum is to be removed. The roll of aluminized film or web printed with the chemical resist pattern by the gravure cylinder is then passed through an aluminum removing chemical bath (e.g., sodium hydroxide) or an acid wash which etches away the aluminum in those areas where there is no chemical resist and leaves the aluminum that is protected by the chemical resist in step 920.

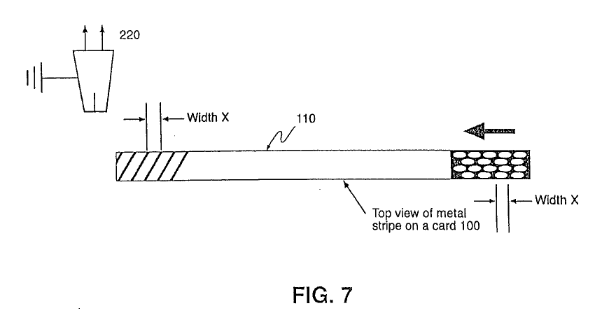

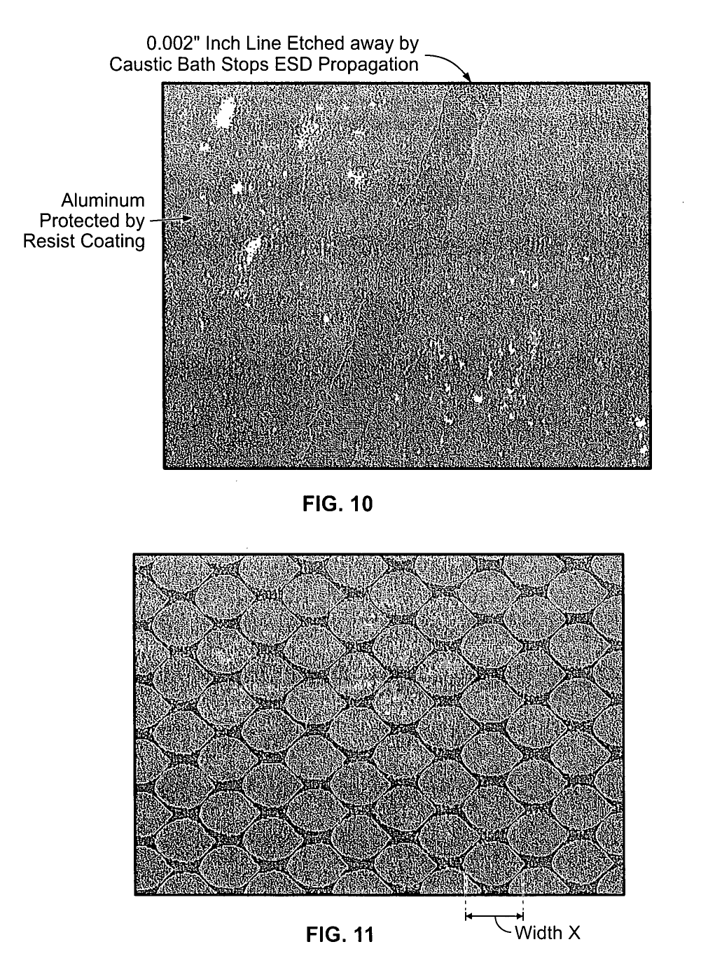

The caustic chemical solution is washed off the demetalized web in step 930. The magnetic and other coatings are then applied to the demetalized web. An example of the line demetalization of the aluminized film is shown in FIGS. 7 and 10 and an example of the dot pattern demetalization process is shown in FIGS. 7 and 11. The line patterns shown in FIG. 7 comprise parallel lines or sections of aluminum of a specific spacing and width. The dot pattern shown in FIG. 7 comprises dots of various shapes such as elliptical or circular shapes. The bright areas represents the aluminum islands or sections 140 of the metal layer and the dark areas represents the gaps 130, where the aluminum has been removed by the caustic chemical bath after the aluminum islands have been protected by the selectively applied chemical resist.

It is appreciated that although the demetalization process described herein involves the use of caustic wash after the application of a caustic resist mask, other known demetalization or other techniques can be utilized in the present invention to generate a fragmented or discontinuous conductive layer or surface. In accordance with an exemplary embodiment of the present invention, the fragmented conductive layer can be generated using a demetalization process, which applies an etching agent directly onto the metalized or conductive surface followed by a rinse with a washing solution. Alternatively, in accordance with an exemplary embodiment of the present invention, the fragmented conductive layer can be generated by applying a water soluble material to the un-metalized holographic surface, metalizing the holographic surface and treating the metalized holographic surface with a wash to dissolve the water soluble material and the covering metal.

The demetalization process of the present invention is used to generate a discontinuous aluminum or other metal layer such that the conductivity and capacitance of the metal layer is significantly changed. The ESD energy/charge stored in each isolated section 140 of the aluminum layer is much less than the continuous metal layer. The separation of each section 140 (or an aluminum island) increases the electrical resistance, thereby making it difficult for the accumulated charge in a section 130 to discharge into an electronic device 200.

The demetalization process should be carefully controlled so that there is no metal remaining in the gap 130 between the metal sections 140. This may require sufficient application of the caustic wash that etches the aluminum away between the resist patterns. Any metal material left in the gap 130 between the metal sections 140 can bridge the metal sections 140, thereby providing conductive paths sufficient to produce ESD into the electronic device 200. However, if the caustic wash is too aggressively applied, it can breakdown the metal area protected by the resist pattern and reduce the aluminum areas (or the metal sections 140) that are meant to be kept. This will decrease the brightness and image quality of the holographic image.

In accordance with an exemplary embodiment of the present invention, the method generates a discontinuous metal layer by generating a demetalized (or selectively metalized) dot pattern (e.g., “Halftone Pattern”) with a sufficiently high dot density to reconstruct the holographic image but not high enough to cause the halftone dots from “connecting”. That is, the dot density is sufficiently low to prevent the halftone dots from “connecting” as shown in FIG. 11. For example, the holographic image can be reconstructed without causing the halftone dots from connecting when the dot density, i.e., the percentage of coverage of metal “dots” relative to the total area of the conductive component was greater than 50%. For certain applications, the dot density or coverage can or should be greater than 70% to increase the brightness of the holographic image. In accordance with an embodiment of the present invention, the halftone dot pattern techniques are used to generate a discontinuous metal layer with the highest dot density without connecting dots.

The process of generating a discontinuous metal layer by selectively removing sections of metal from the metal layer of the holographic tape reduces or blocks the ESD from reaching the sensitive components of the electronic device, such as the magnetic read head, by decreasing the capacitance, the amount of charge that can be stored on any one or more aluminum section and increasing the resistance of the metal layer.

In accordance with an embodiment of the present invention, a discontinuous metal layer 110 can be generated by selectively applying discontinuous metal pattern on the non-conducting carrier or substrate 100. The discontinuous metal pattern can comprise discrete metal sections of limited area to prevent or minimize the accumulation of charge in a given area. Each section 140 is separated from an adjacent section by a sufficient distance so that the accumulated charge in one section 140 cannot arc across the gap 130 to another section 140.

The present invention generates a discontinuous metal layer 110 (i.e., small isolated areas of metal) on a non-conducting substrate 100 by selectively removing metals from a continuous metal layer 110 on the non-conducting carrier 100 or by selectively applying the metal on the non-conducting carrier 100. Various metal removing, metal printing or deposition techniques can be utilized in the present invention to generate small areas of metal that are sufficiently isolated from one another (i.e., a discontinuous metal layer) to block ESD into any electronic device 200, including those with low tolerance to ESD.

In accordance with an embodiment of the present invention, the metal removal and metal addition methods into fixed patterns should satisfy the two criteria: a) minimum accumulation of charge (i.e., minimum area of metal coverage consistent with brightness of image carried by the metal area) and b) prevention of the metal sections 140 from connecting to one another so that the charge accumulated on each section 140, by various methods, cannot discharge in combination with other metal sections 140 to generate an ESD of damaging current or voltage to an electronic device 200.

It is appreciated that the actual path of charge migration to the point of discharge is mediated by the presence of the embedded conductive layer 110, the electrical resistance is determined by the integrity of the metal layer 110. The resistance of the metal layer 110 depends on the fragmentation of the metal. The electrical resistance of the metal layer 110 increases with the metal fragmentation (i.e., a discontinuous metal pattern), which reduces the propagation of the accumulated charge on the conductive layer 110. Turning now to FIGS. 1 and 4, where the accumulated charges propagate from right to left across the width of the metalized stripe 110 along the leading vertical (top) edge of the card 100, the present invention can employ any mechanism that induces a break-up of this conductive path to prevent electrostatic discharge from occurring along any exposed edges of the magnetic stripe or from the body of the magnetic stripe.

In accordance with an exemplary embodiment of present invention, deeply etched diffractive elements, strategically embodied within the holographic image, are employed with mechanical embossing, the concomitant deformation and fragmentation of typical holographic pre-metalized foils to disrupt the metal layer 110 or the conductive path. This purposeful microscopic disruptions in the metal layer 110 effectively impede charge propagation, thereby reducing or preventing electrostatic discharge from occurring along any exposed edges of the non-conductive carrier 100.

The present invention has application in any non-conductive carrier having a conductive component that interfaces with an electronic device, human subject or object. Anywhere that a combination of a conductive portion or element is on or in a non-conducting carrier, the conductive element can potentially retain electrostatic charge and discharge that accumulated charge into an electronic device when the carrier and conductor combination interfaces with the electronic device. In accordance with an embodiment of the present invention, fragmenting or dividing the conductive portion into smaller sections reduces the charge accumulated on each area and isolating these sections blocks any potential discharge of the accumulated charge into the electronic device. The following is an illustrative example of various applications of the present invention:

A metalized magnetic tape by itself can carry a metal layer and a non-conducting carrier such as a polyester backing which could develop ESD when used in conjunction with a tape read/write device without having the metalized tape mounted or attached to a secondary non-conducting carrier. The metalized portion of the tape when divided by the processes described in this embodiment of the present invention would prevent ESD build up and discharge into any device, human or system when using or handling the metalized tape on the non-conducting tape backing.

The metalized holographic thread 1210 or metalized holographic patch 1220 on paper or plastic banknotes 1200 can carry a charge that potentially can discharge into a banknote acceptor. In accordance with an exemplary embodiment the present invention, the metal layer of the holographic ribbon 1210 or the holographic patch 1220 can be fragmented or divided into small isolated metal sections to reduce or eliminate any potential ESD into a banknote acceptor while maintaining the visual appearance of the holographic ribbon 1210 or the holographic patch 1220.

Holograms on plastic cards that are not part of the magnetic stripe are typically used for visual security and design on many payment cards. If the metal layer in the hologram is of sufficient size and location, it can also accumulate a charge from the triboelectric charge generation and potentially discharge into a POS terminal through the magnetic read head, a ground path, or the chip reader. In accordance with an exemplary embodiment of the present invention, the metal layer in the hologram can be fragmented or divided into sections to reduce or minimize any potential ESD into the POS terminal.

Metal batteries in plastic cards are used to provide power for RF-ID cards and displays. In accordance with an exemplary embodiment of the present invention, the surface of the battery can be fragmented or divided into smaller metal sections to reduce or minimize any potential ESD into the reader.

The contact pads on smart cards are metallic and interfaces (i.e., contacts) with the read circuits of the smart card reader. In accordance with an exemplary embodiment of the present invention, the contact pads are fragmented or divided into smaller metallic sections to minimize or reduce any potential ESD into the smart card reader while still maintaining the electrical contact of the large pin connector that communicates with the chip in the card.

Further, there are many other applications where it may be advantageous to reduce or eliminate any potential ESD from a device to another device or a person. For example, metal surgical instruments in a high oxygen atmosphere can benefit from a metallic surface over an insulator that has been divided into many smaller low capacitance sections. A pace maker in a human heart can benefit from being enclosed in a metal case that has a surface fragmented into small metallic sections to reduce any potential harm from electromagnetic induction or ESD.

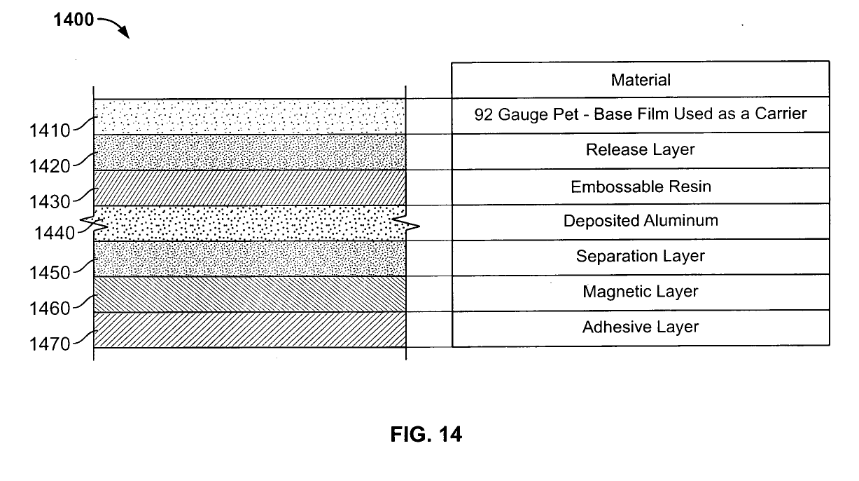

In accordance with exemplary embodiments of the present invention, the use of the signal modulation from the demet pattern of a holographic magnetic stripe or tape (can be used to enhance the security of the magnetic stripe to defeat skimming. An example of a fully constructed holographic magnetic tape 1400 without the demet pattern prior to its application to a card is shown in FIG. 14. The total thickness of the tape is approximately between 38-42 μm. The tape generally comprises the following layers: a base film 1410, a release layer 1420; an embossable resin layer 1430; a reflective layer 1140, preferably a metal layer, such as aluminum, chrome, cooper, aluminum/chrome alloy and the like; a separation layer (e.g., a tie coating layer) 1450; a magnetic layer 1460; and an adhesive layer 1470. The separation layer or coat 1450 on top of the reflective layer 1420 adds additional spacing between the upper surface of the tape (when actually disposed on a card as shown in FIG. 2A) and the magnetic layer 1460 where the data is encoded. It is well known that even a small separation of the magnetic read head 220, which is in contact with the upper surface of the tape, and the magnetic layer 1460 will produce a signal loss when reading the encoded data. Generally, the magnetic signal amplitude and jitter of the encoded magnetic signal read from the magnetic stripe card is within the ISO magnetic stripe specifications.

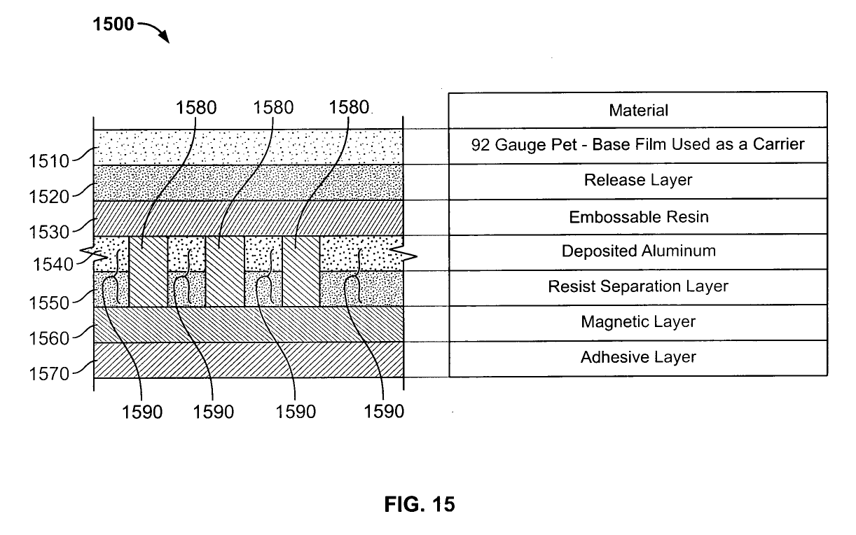

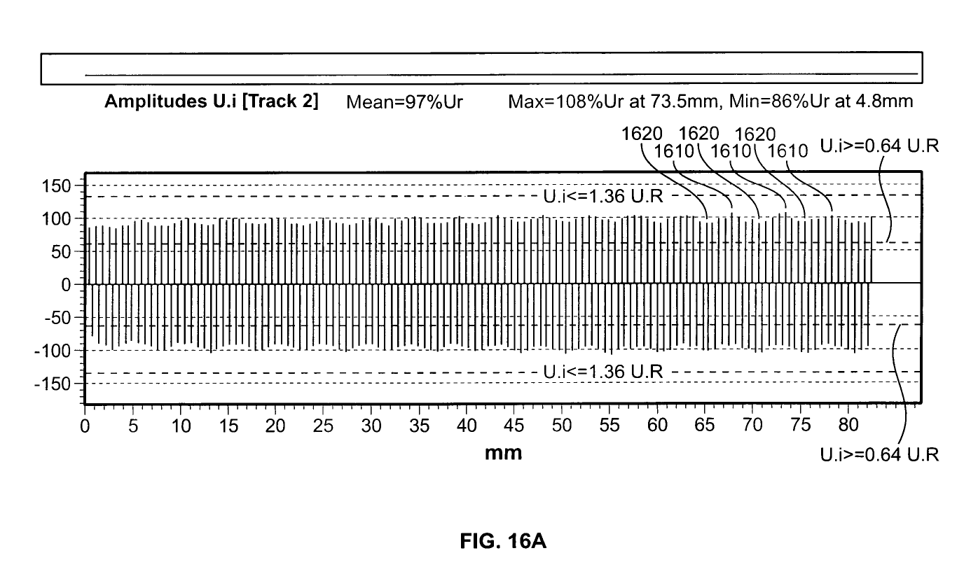

The present invention proceeds on the desirability of enhancing the readback signal amplitude due to the spacing loss between the magnetic layer 1460 and the upper surface of the tape by selectively removing portions of the reflective or metal layer 1440 by a demetalization or laser ablation process. An exemplary holographic magnetic tape 1500 in accordance with an embodiment of the present invention is shown in FIG. 15. As explained herein, one method of selectively removing the portions of the metal layer (i.e., aluminum) 1540 is the demet process that utilizes a printed resist coating or resist separation layer 1550 of a specific design applied to the metal portion of the metal layer or stripe 1540 in a web format. This resist pattern protects the metal from the chemical caustic wash that follows the printing of the resist pattern. The chemical wash removes the metal layer 1540 where the resist pattern is not printed. After the demet process is completed the holographic metal web can be coated with additional coatings, such as magnetic oxide coating to form a magnetic layer 1560 and adhesive coating to form an adhesive layer 1570.

In the areas where the metal (i.e., aluminum) has been removed by the caustic wash, the magnetic layer 1560 is now closer to the upper surface of the tape (when disposed on a demet holographic magnetic card as shown in FIG. 2A) and therefore will produce a stronger readback signal in the magnetic read head 220 at the POS terminal 200 (see FIGS. 1, 3, 4, 7). The readback signal will have a higher signal amplitude over an area 1580 of the holographic magnetic tape 1500 where there is minimum or no resist/metal coatings (now filled with the magnetic oxide coating) and lower signal amplitude over an area 1590 where there is a maximum of number of the resist/metal coatings.

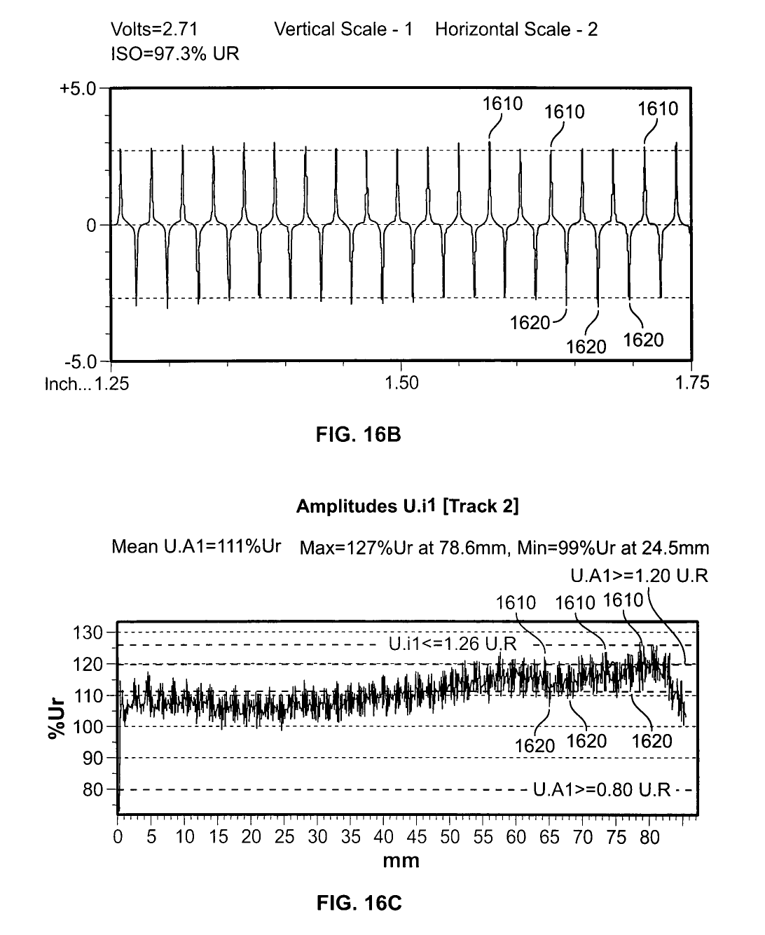

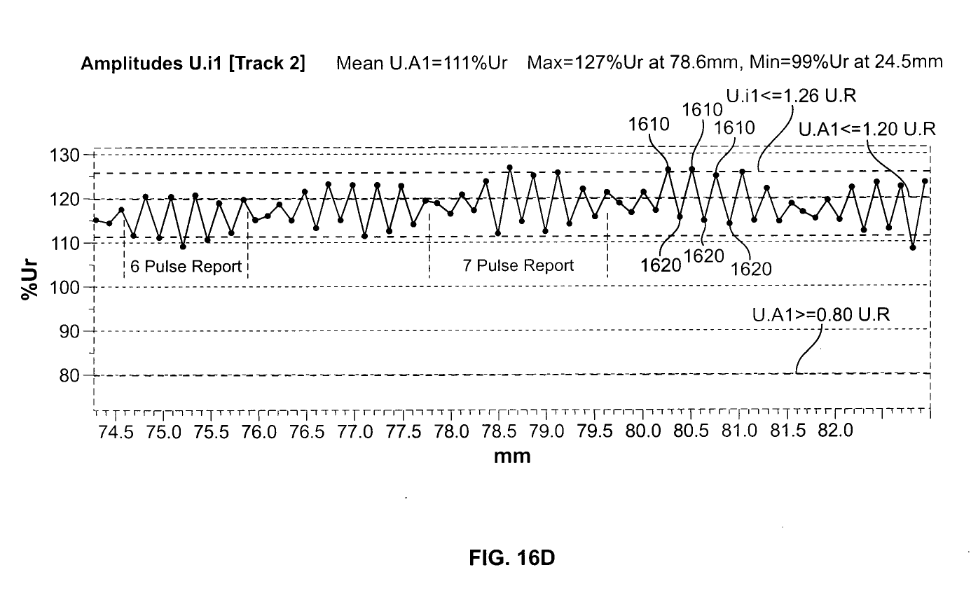

FIGS. 16A-D are graphs showing such a variation in signal amplitude from Track 2 on a demet holographic magnetic stripe card 100 for a data recording of all binary zeroes in accordance with an exemplary embodiment of the present invention. The repeating modulation pattern of the signal amplitude is due to the repeating pattern of the resist/aluminum areas 1590 and the areas 1580 where there is no resist/aluminum coverage. The maximum peaks such as the exemplary peaks 1610 in the signal amplitude occur where the magnetic read head 220 is over a section of the holographic magnetic tape 1500 where there is more areas 1580 (areas with minimal or no resist/aluminum coatings) than areas 1590 and the minimum peaks such as the exemplary peaks 1620 in the signal amplitude occur where the magnetic read head 220 is over a section of the holographic magnetic tape 1500 where there is more areas 1590 (areas with resist/aluminum coatings) than areas 1580. The repeat pattern in FIG. 16D is six (6) pulses as shown by exemplary pattern 1630 to seven (7) pulses as shown in exemplary pattern 1640 depending on the exact positions of areas 1580, 1590. The signal amplitude variation resulting from the resist/aluminum pattern of the present invention superimposed on the encoded magnetic signal of the demet holographic magnetic stripe card 100 is small enough to maintain the magnetic signal amplitude and jitter within the ISO magnetic stripe specifications.

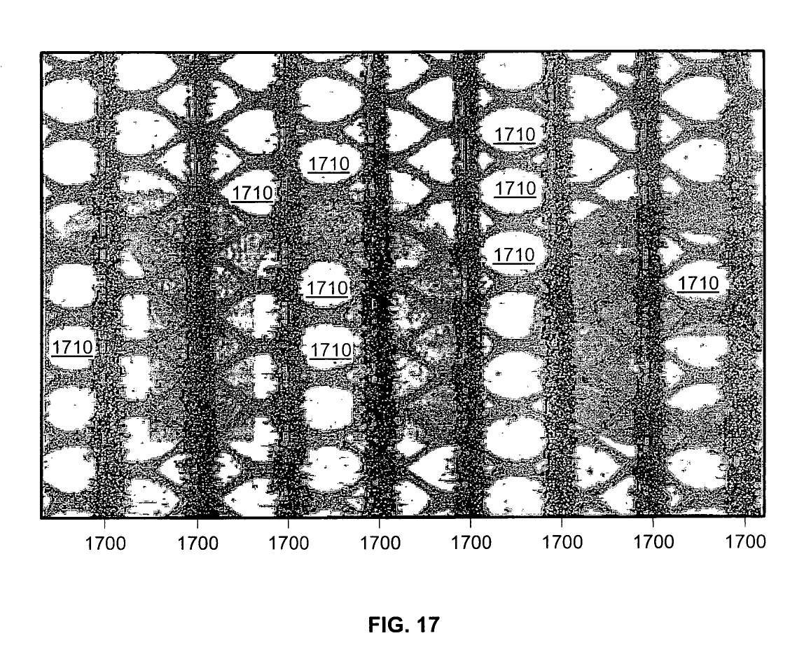

A photomicrograph of the encoded magnetic signal in Track 2 for all binary zeroes according to an exemplary embodiment of the present invention is shown in FIG. 17. The dark lines 1700 are the edges of the encoded binary zero made visible by use of a magnetic powder that clings to the edges of the magnetized zone that defines the binary zero. In between the dark lines 1700-1700 marking the boundaries of the binary zero are the resist/aluminum areas 1590 of the holographic magnetic tape 1500 of the present invention as shown by exemplary areas 1710 The top modulation pattern of the positive pulses shown in FIGS. 16A-D, such as exemplary peaks 1610, matches the amount of resist/metal dots 1710 directly under the dark lines 1700. The dark lines 1700 corresponds to the edge of the binary bit where the encoded magnetic signal strength is at a maximum. The greater the number of metal dots 1710 under the dark binary data bit edge 1700, the lower the readback signal amplitude as shown by exemplary peaks 1620. The fewer the number of metal dots 1710 under the dark binary data bit edge 1700, the higher the readback signal amplitude as shown by exemplary peaks 1610. The readback signal amplitude can be modulated in a predetermined repetitive pattern (such as the exemplary patterns 1630, 1640 shown in FIGS. 16A-D) in accordance with an exemplary embodiment of the present invention by printing the metal dots 1710 in a predetermined repetitive distance.

In accordance with an embodiment of the present invention, this modulated signal amplitude can serve as a marker location along the holographic magnetic tape 1500 and along the encoded data. It is appreciated that the demet pattern can be random down the length of the holographic magnetic stripe and therefore the modulation of the signal amplitude is also random down the length of the holographic magnetic stripe. In an exemplary embodiment of the present invention, this modulation can be used as a magnetic signature or fingerprint for the encoded data stored on the holographic magnetic stripe.

In accordance with an exemplary embodiment of the present invention, the modulation pattern of the magnetic signal amplitude generated by the demet aluminum/resist pattern is a strong, repetitive and consistent signal that can be used as a fingerprint of the holographic magnetic stripe and encoded data. The signal modulation pattern can be uniform as shown in FIGS. 16A-B and 17 due to a uniform metal/resist dot pattern in the demet structure of the holographic magnetic tape 1500. Alternatively, the signal modulation can be varied by introducing a variable metal/resist pattern into the demet structure of the holographic magnetic tape 1500.

The signal modulation pattern can be used to lock the encoded data to the demet holographic magnetic card 100 by identifying where the encoded data falls with respect to the signal modulation pattern in accordance with an exemplary embodiment of the present invention. For example, the fifth peak in the signal modulation pattern can correspond to the third leading edge of the second character in the primary account number encoded on holographic magnetic stripe 1500. This spatial relationship can be locked into the card 100 by the fixed relationship of the metal/resist or demet dots 1710 and the encoded data. If the encoded data from this card 100 is skimmed to another demet holographic magnetic card, the fraudulent card can be easily detected because the new card will not have the same spatial relationship between the metal/resist dots 1710 and the encoded data, thereby providing unparallel level of security.

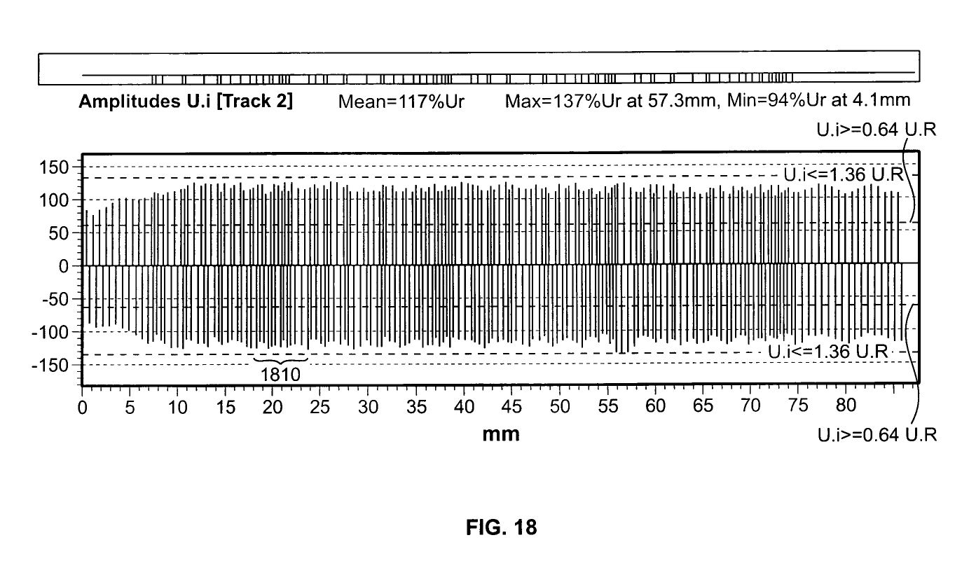

FIG. 18 is a graph showing the variation in signal amplitude from Track 2 data encoded on top of the holographic magnetic stripe 1500 according to an exemplary embodiment of the present invention. The encoded data is modulated into a modulation pattern based on the demet dots 1710. The difference between FIGS. 16A-D and FIG. 18 is that the modulation or demet modulation shown in FIGS. 16A-D is for data of all binary zeroes to make the demet modulation of the signal amplitude clearly visible. In FIG. 18 the modulation pattern is superimposed on both binary zeroes and binary ones of time-varying two-frequency or frequency double frequency (F2F) or bi-phase encoded data. The binary one is twice the frequency of a binary zero in F2F encoding and therefore the pulses are twice as closer together as compared to the binary zeroes. The closeness of the pulses causes some signal loss (pulse crowding) and therefore the signal amplitude of the binary one is lower than the signal level of the binary zero in all magnetic encoding as shown by the exemplary peaks 1810.

In accordance with an exemplary embodiment of the present invention, the system and method can take into account the inherent differences in signal amplitude in the binary ones and zeroes in addition to the differences caused by the demet modulation. As can be seen in FIG. 18, the demet modulation on the overall signal amplitude envelope can be identified by the demet dot pattern. In addition, the trailing zeroes can also be used to establish the timing sequences of just binary zeroes due to the demet dot pattern in the trailing zeroes area of the card 100. The present invention can then synchronize on the location of the encoded data based on the presence of both binary zeroes and ones to provide a magnetic signature of the holographic magnetic stripe 1500 in accordance with an exemplary embodiment of the present invention.

In an exemplary embodiment of the present invention, the magnetic signature of the card can be changed by changing the demet pattern, such as changing the dot density. This advantageously permits the magnetic signature to be used identify the cards by brand or company. The present invention is amenable to rapid identification in the field using inexpensive portable verification devices that recognizes the demet pattern to identify the card's brand. Varying the demet pattern can also provide additional level of security by providing a more random association of the encoded data to the demet pattern. This approach can provide the additional security needed for off line verification of the encoded data locked to the card at the POS terminal level.

The POS terminal 200 (or corresponding demet security algorithm for verifying the card) needs to updated minimally to practice the present invention. For example, the decoder in the POS terminal needs to be updated to recognize the spatial relationship between the encoded data and the demet modulation of the magnetic signal read from the card. In an exemplary embodiment of the present invention, the demet security algorithm or demet modulation decoding functionality (which can be embodied in either software and/or hardware) can be incorporated into the standard F2F data decode chip of the magnetic stripe readers 220. The output of the demet security algorithm can be an offset value encoded on the holographic magnetic stripe 1500, such as in a security field. In this case the authenticity of the data on that card can be determined off line and not involve the issuing bank's data base because the present invention compares the magnetic signature of the card (i.e., the offset value) to the encoded offset value. In an alternate embodiment, the authenticity can also be established by sending the offset value back to the database after every read attempt to compare with the authenticity offset established at initial encoding.

Previously proposed magnetic stripe security techniques suffered significant drawbacks. A main drawback of such proposed methods was their significant impact on the POS reading terminal. For example, in order to implement the current solutions, either the magnetic stripe card, read head, decode electronics and/or the bank's database had to be completely changed which inevitably would have a significant cost impact on the whole POS infrastructure. The holographic demet security of the present invention, however, has no impact on the magnetic read head. In fact it is insensitive to variations in read head location and wear conditions common in POS terminals in the financial markets. Accurate positioning of the read head in POS terminals will not be required as it is in other forms of magnetic data security derived from inherent properties of the magnetic stripe (noise or jitter).

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, and composition of matter, means, methods and steps described herein. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed:

1. A secured holographic magnetic tape, comprising:
a magnetic layer for encoding data;
an embossable layer for embossing a hologram; and
a metal layer comprising a plurality of sections forming a pattern based on a predetermined magnetic signature of said tape.

2. The secured holographic magnetic tape of claim 1, wherein said magnetic signature represents a spatial relationship between said predetermined pattern and said encoded data.

3. The secured holographic magnetic tape of claim 1, wherein said encoded data is represented by a magnetic signal when read; and wherein said magnetic signature corresponds to amplitude variations in said magnetic signal.

4. The secured holographic magnetic tape of claim 1, wherein said pattern is a uniform pattern.

5. The secured holographic magnetic tape of claim 1, wherein said pattern is a variable pattern.

6. The secured holographic magnetic tape of claim 1, wherein said magnetic signature corresponds to a location of said encoded data.

7. The secured holographic magnetic tape of claim 1, wherein said plurality of sections are formed by selectively removing portions of said metal layer by a demetalization process or laser ablation process.

8. The secured holographic magnetic tape of claim 2, wherein said spatial relationship is represented by an offset value and said encoded data comprises said offset value.

9. A holographic magnetic tape card, comprising:
a carrier; and
a secured holographic magnetic tape on said carrier, comprising:
a magnetic layer for encoding data;
an embossable layer for embossing a hologram; and
a metal layer comprising a plurality of sections forming a pattern based on a predetermined magnetic signature of said tape.

10. The holographic magnetic tape card of claim 9, wherein said magnetic signature represents a spatial relationship between said predetermined pattern and said encoded data.

11. The holographic magnetic tape card of claim 9, wherein said encoded data is represented by a magnetic signal when read; and wherein said magnetic signature corresponds to amplitude variations in said magnetic signal.

12. The holographic magnetic tape card of claim 9, wherein said predetermined pattern is a uniform pattern.

13. The holographic magnetic tape card of claim 9, wherein said predetermined pattern is a variable pattern.

14. The holographic magnetic tape card of claim 9, wherein said magnetic signature corresponds to a location of said encoded data.

15. The holographic magnetic tape card of claim 9, wherein said plurality of sections are formed by selectively removing portions of said metal layer by a demetalization process or laser ablation process.

16. The holographic magnetic tape card of claim 10, wherein said spatial relationship is represented by an offset value and said encoded data comprises said offset value.

17. The holographic magnetic tape card of claim 9, wherein said card is one of the following: a credit card, an automatic teller machine (ATM) card, a transit card, a phone card, a charge card, a stored-value card, a gift card or a debit card.

18. A method of securing a holographic magnetic tape, comprising the steps of:
depositing an embossable resin layer for embossing a hologram on a base film;
depositing a metal layer;
dividing said metal layer into a plurality of sections to form a pattern based a predetermined magnetic signature of said tape; and
depositing a magnetic layer for encoding data.

19. The method of claim 18, further comprising the step of establishing said magnetic signature based on a spatial relationship between said predetermined pattern and said encoded data.

20. The method of claim 18, further comprising the step of representing said encoded data by a magnetic signal when read; and establishing said magnetic signature based on amplitude variations in said magnetic signal.

21. The method of claim 18, wherein the step of dividing comprises the step of dividing said metal layer into a plurality of sections to form a uniform pattern based a predetermined magnetic signature of said tape.

22. The method of claim 18, wherein the step of dividing comprises the step of dividing said metal layer into a plurality of sections to form a variable pattern based a predetermined magnetic signature of said tape.

23. The method of claim 18, further comprising the step of establishing said magnetic signature based on a location of said encoded data.

24. The method of claim 18, wherein the step of dividing comprises the step of selectively removing portions of said metal layer by a demetalization process or laser ablation process.

25. The method of claim 19, wherein said spatial relationship is represented by an offset value and further comprising the step of encoding said offset value.

26. The method of claim 25, further comprising the step of authenticating said tape by comparing said offset value derived from said magnetic signature to said encoded offset value.
